(19) United States
(12) Patent Application Publication
(10) Pub. No.: US 2020/0191484 A1
(43) Pub. Date: Jun. 18, 2020

(54) Cooling Vessel for Metal Recovery from Smelting or Melting Waste Products

(71) Applicants: TMS International Corporation, Glassport, PA (US); TMS International South Africa (Pty) Limited, Greenstone (ZA)

(72) Inventors: Detlef Klapthor, Johannesburg (ZA); Rudolf Johan van Rooyen, Pretoria (ZA); William R. Miller, North Wales, PA (US); Michael A. Costa, West Chester, PA (US)

(21) Appl. No.: 16/475,520

(22) PCT Filed: Jan. 10, 2018
(86) PCT No.: PCT/US2018/013129

§ 371 Date: Jul. 2, 2019

Related U.S. Application Data
(60) Provisional application No. 62/445,036, filed on Jan. 11, 2017.

(51) Int. Cl. F27B 14/10; F27B 14/02; F27D 9/00

(52) U.S. Cl. CPC F27B 14/10; F27D 9/00; F27B 14/02

(57) ABSTRACT

A cooling vessel for metal recovery from waste products including a first open end, a second closed end, and a sidewall extending between the first open end and the second closed end. The vessel has a longitudinal central axis extending from the first open end to the second closed end. In a plane including the longitudinal axis and extending from the first open end to the second closed end, opposing interior surfaces of the vessel are at an angle of 30°-50° to one another. The thickness of the sidewall adjacent the second closed end is greater than the thickness of the sidewall at the first open end. A diameter of the inner surface of the vessel along a first major axis may be greater than a diameter of the inner surface of the vessel along a second minor axis such that a cross-section of the vessel is oval.

### CROSS REFERENCE TO RELATED APPLICATIONS

This application claims priority to U.S. Provisional Application Ser. No. 62/445,036 filed on Jan. 11, 2017, the disclosure of which is hereby incorporated in its entirety by reference.

### BACKGROUND OF THE INVENTION

### Field of the Invention

This invention relates to a cooling vessel for metal recovery from waste products, such as slag, created during the primary smelting or melting of the metal.

### Description of Related Art

U.S. Pat. No. 4,046,323, herein incorporated by reference, describes processes for recovering metal from non-ferrous slags produced in smelting operations. In the disclosed processes, the slag is placed in a ladle and allowed to slow cool until it is either substantially solidified or has formed a sufficient outer shell to allow it to be removed from the ladle as a solidified mass and then further cooled outside of the ladle. Cooling agents, such as water, may be added to the ladle. The solidified mass is then crushed, milled, and metal is recovered using a flotation process. Slag solidified using this slow cooling in a ladle results in higher copper recovery during flotation than can be achieved from slag that has been fast cooled in a pit. While not discussed in U.S. Pat. No. 4,046,323, it has also been found that a copper rich material that can be directly reused in the smelting process without flotation settles to the bottom of the ladle. However, the slow cooling process is time consuming and may take from 50-60 hours. Therefore, there is a desire to decrease the production time required to recover the metal from the slag.

### BRIEF DESCRIPTION OF THE DRAWINGS

FIG. 1 is a right front perspective view of one embodiment of the cooling vessel according to the present invention;

FIG. 2 is front view of the cooling vessel of FIG. 1;

FIG. 3 is side view of the cooling vessel of FIG. 1;

FIG. 4 is top view of the cooling vessel of FIG. 1;

FIG. 5 is a right front perspective view of another embodiment of the cooling vessel according to the present invention;

FIG. 6 is front view of the cooling vessel of FIG. 5;

FIG. 7 is side view of the cooling vessel of FIG. 5;

FIG. 8 is top view of the cooling vessel of FIG. 5;

FIG. 9 is bottom view of the cooling vessel of FIG. 5;

FIG. 10 is cross-sectional view along line 12-12 in FIG. 6;

FIG. 11 is an enlarged view of a portion of FIG. 6;

FIG. 12 is an enlarged view of a portion of FIG. 7; and

FIG. 13 is an enlarged view of a portion of FIG. 10;

### SUMMARY OF THE INVENTION

The present invention is directed to a cooling vessel for metal recovery from waste products comprising a first open end, a second closed end, and a sidewall extending between the first open end and the second closed end. The vessel has a longitudinal central axis extending from the first open end to the second closed end. In a plane including the longitudinal axis and extending in a direction from the first open end to the second closed end, opposing interior surfaces of the vessel are at an angle of 30°-50° to one another, and the thickness of the sidewall at the first open end is greater than the thickness of the sidewall adjacent the second closed end. A ratio of the thickness of the sidewall at the first open end to the thickness of the sidewall adjacent the second closed end may be 1.1-2.0.

For a cross-section of the vessel taken perpendicular to the longitudinal central axis, an inner surface of the vessel may have a first major axis and a second minor axis, and the diameter of the inner surface of the vessel along the first major axis may be greater than the diameter of the inner surface of the vessel along the second minor axis. A ratio of the diameter of the inner surface of the vessel along the first major axis to the diameter of the inner surface of the vessel along the second minor axis may be 1.05-1.50. The cross-section of the inner surface of the vessel may be oval.

The interior surface of the second closed end may be rounded. The second closed end may have a thickness that is equal to or greater than the thickness of the sidewall adjacent the second closed end, and the ratio of the thickness of the sidewall adjacent the second closed end to the thickness of the second closed end may be 0.8-1.0.

The cooling vessel may further comprise a reinforcement ring provided at the first open end, where the reinforcement ring has a thickness that is greater than a thickness of the sidewall at the first open end and creates a flange extending laterally outward from the sidewall.

The cooling vessel may also further comprise a plurality of cooling fins extending laterally outward from the exterior surface of the sidewall and upward along the exterior surface of the sidewall from the second closed end. The plurality of cooling fins may extend 0.1-0.6 of the length of the sidewall as measured from the first open end to the second closed end.

### DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, “proximal”, “distal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting. As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1. Plural encompasses singular and vice versa. When ranges are given, any endpoints of those ranges and/or numbers within those ranges can be combined with the scope of the present invention. “Including”, “such as”, “for example” and like terms means “including/such as/for example but not limited to”.

The present invention is directed to a cooling vessel for recovering metal from waste products created during the primary smelting or melting of the metal. The metal may be non-ferrous or ferrous, for example, copper, iron, titanium, nickel, chromium, and manganese and the waste product may be slag. The waste product is provided to the cooling vessel in the molten state and subsequently cooled to separate metal-containing material from waste material containing little or no metal.

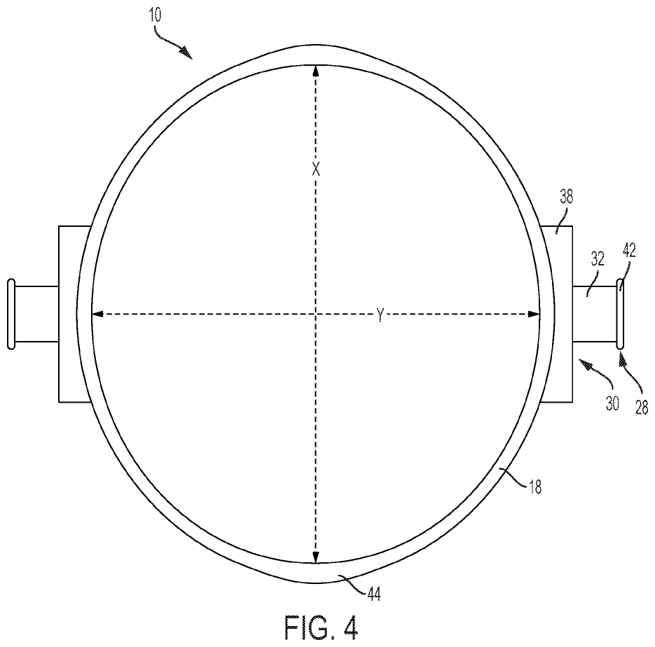

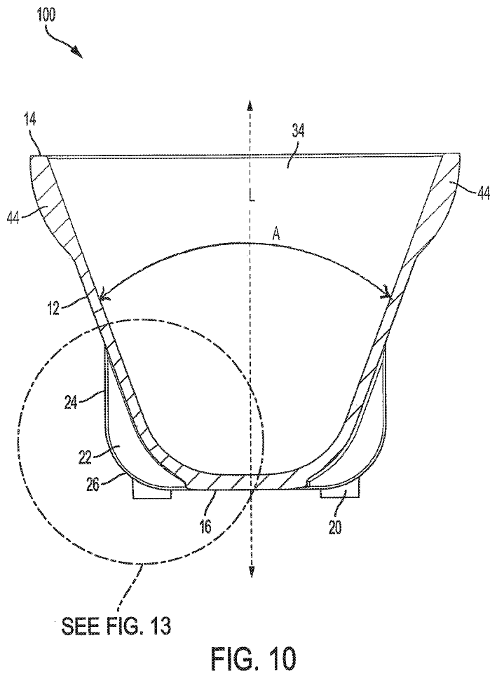

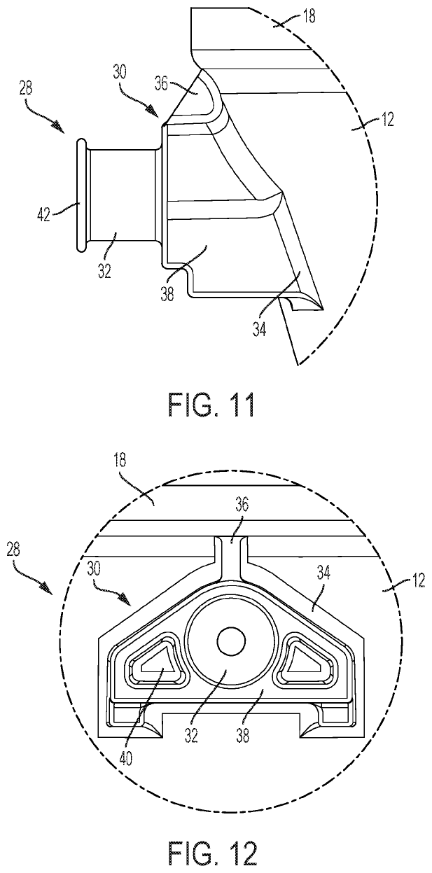

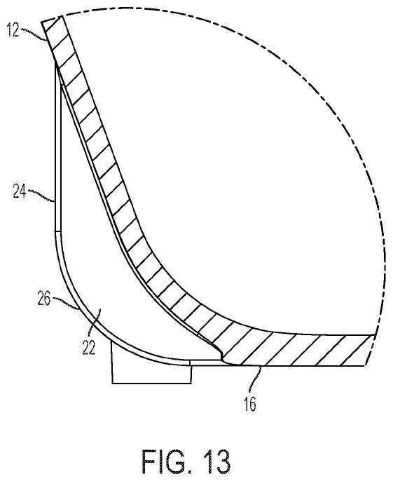

The cooling vessel 10, 100 has a continuous sidewall 12 extending from an open top end 14 to a closed bottom end 16. As shown in FIGS. 4 and 10, the cross-section of the sidewall 12 taken perpendicular to a longitudinal axis L extending from the open top end 14 to the closed bottom end 16 may be an ellipse or oval having a major axis X that is perpendicular to a minor axis Y. The inner surface of the sidewall 12 may have a diameter along the major axis X (Dₘₐⱼ) that is greater than the diameter along the minor axis Y (Dₘᵢₙ). The ratio Dₘₐⱼ/Dₘᵢₙ of the diameter along the major axis X (Dₘₐⱼ) to the diameter along the minor axis Y (Dₘᵢₙ) may be at least 1.05 and up to 1.50, for example, 1.05-1.50 or 1.1-1.4. In one embodiment, at the top open end 14 of the cooling vessel 10, 100, the diameter of the major axis X may be 3681 mm and the diameter along the minor axis may be 3300 mm such that the ratio Dₘₐⱼ/Dₘᵢₙ in is 1.12. The sidewall 12 tapers inwardly from the open top end 14 to the closed bottom end 16 such that the diameter along the major axis X and the diameter along the minor axis Y are largest at the open top end 14 and smallest at the closed bottom end 16 and the cross-sectional area defined by the sidewall 12 at the open top end 14 is greater than the cross-sectional area defined by the sidewall 12 at the closed bottom end 16. As shown in FIG. 10, in a plane that includes the longitudinal axis L of the cooling vessel 10, 100, and extends from the open top end 14 to the closed bottom end 16, the interior surfaces of the sidewall 12 are at an angle A of at least 30° and up to 50°, for example, an angle A of 30-50°, an angle A of 35-45°, or an angle A of 38-42°. The portion of the sidewall 12 that connects to closed bottom end 16 may be curved having a series radii of at least 800 and up to 1000 mm, for example, a series radii of 800-1000 mm or a series radii of 850-950 mm as shown in FIG. 13.

The thickness (tₒ) of the sidewall 12 at the open top end 14 is less than the thickness (t_{c}) of the sidewall at the closed bottom end 16 and has a continuous taper from t_{c} to. The ratio (t_{c}/tₒ) of the thickness (t_{c}) of the sidewall 12 at the closed bottom end 16 to the thickness (tₒ) of the sidewall 12 at the open top end 14 may be at least 1.1 and up to 2.0, for example, 1.1-2.0, 1.2-1.7, or 1.3-1.6. The thickness (tₒ) of the sidewall 12 at the open top end 14 may be at least 70 mm and up to 110 mm, for example, 70-110 mm or 80-100 mm, and the thickness (t_{c}) of the sidewall 12 at the closed bottom end 16 may be at least 110 mm and up to 150 mm, for example, 110-150 mm or 100-140 mm. In one embodiment, the thickness (tₒ) of the sidewall 12 at the open top end 14 is 90 mm, the thickness (t_{c}) of the sidewall 12 at the closed bottom end 16 is 130 mm, and the ratio (t_{c}/tₒ) is 1.44.

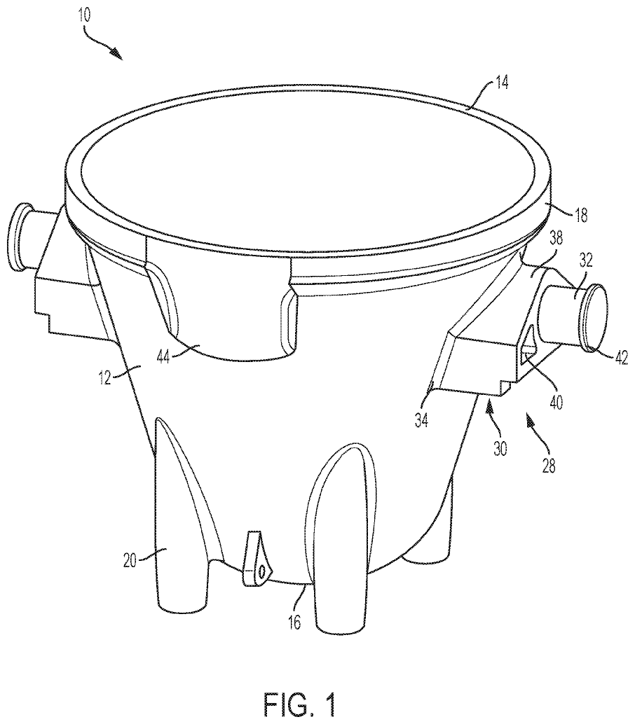

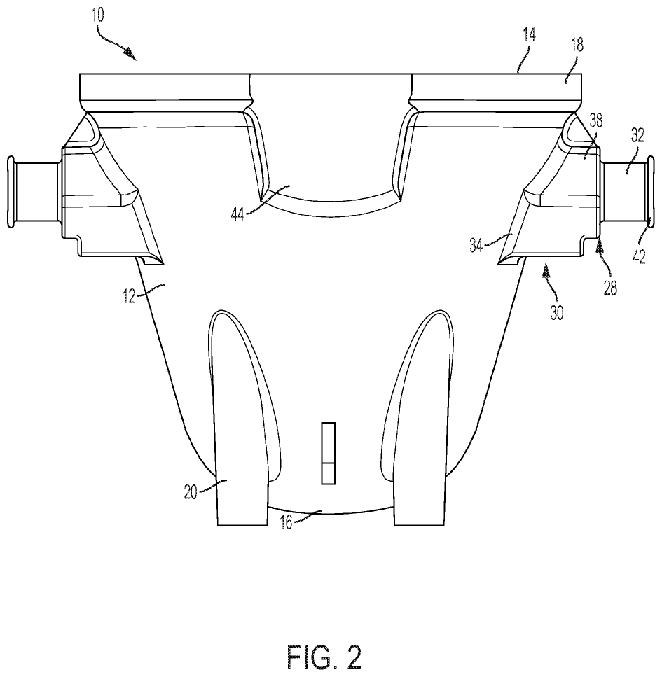

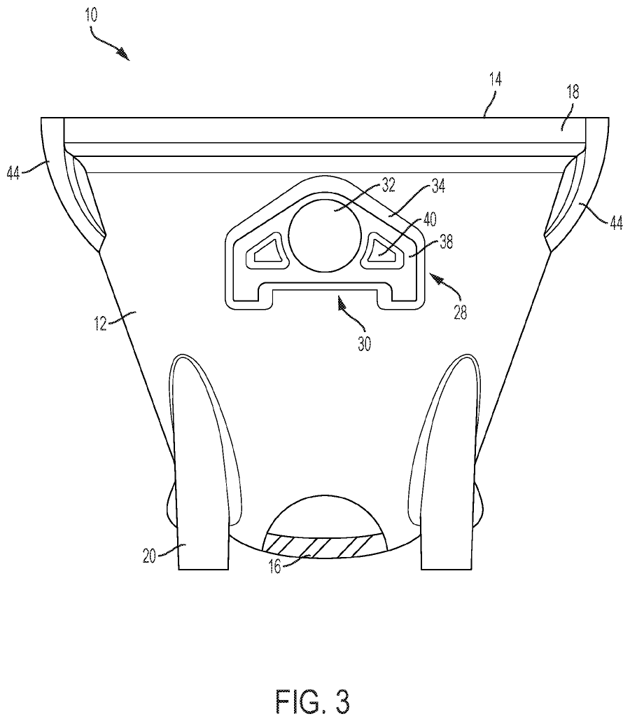

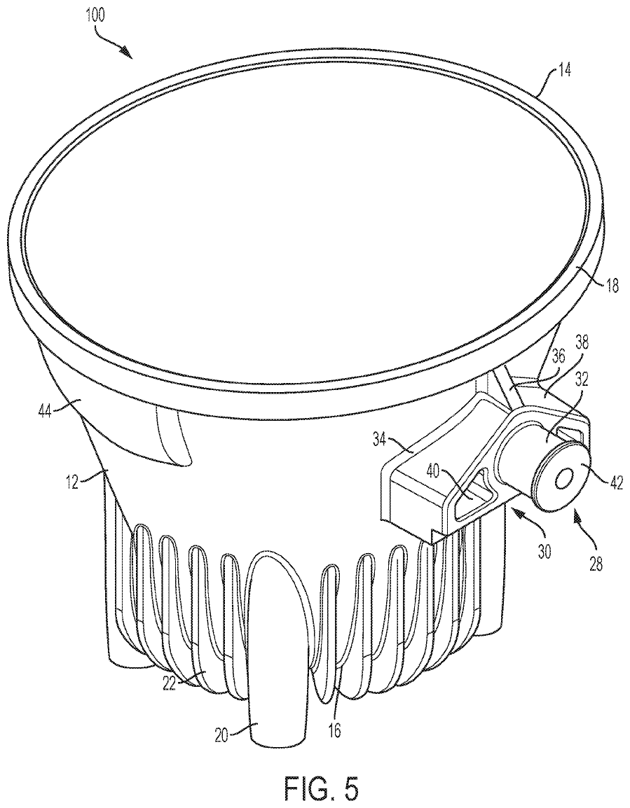

The interior surface of the closed bottom end 16 is rounded, and the exterior surface may also be rounded as shown in FIGS. 1-3 or may be flat as shown in FIGS. 5-7. Also, the closed bottom end 16 may have a thickness (t_{b}) that is equal to or greater than the thickness of the thickness (t_{c}) of the sidewall 12 at the closed bottom end 16. The ratio (t_{c}/t_{b}) of the thickness (t_{c}) of the sidewall 12 at the closed bottom end 16 to the thickness (t_{b}) of the closed bottom end 16 may be at least 0.8 and up to 1.0, for example, 0.8-1.0 or 0.9-1.0. The thickness (t_{b}) of the closed bottom end 16 may be at least 115 mm and up to 155 mm, for example, 115-155 mm or 125-145 mm. In one embodiment, the thickness (t_{c}) of the sidewall 12 at the closed bottom end 16 is 130 mm, the thickness (t_{b}) of the closed bottom end 16 is 135 mm, and the ratio (t_{c}/t_{b}) is 0.97.

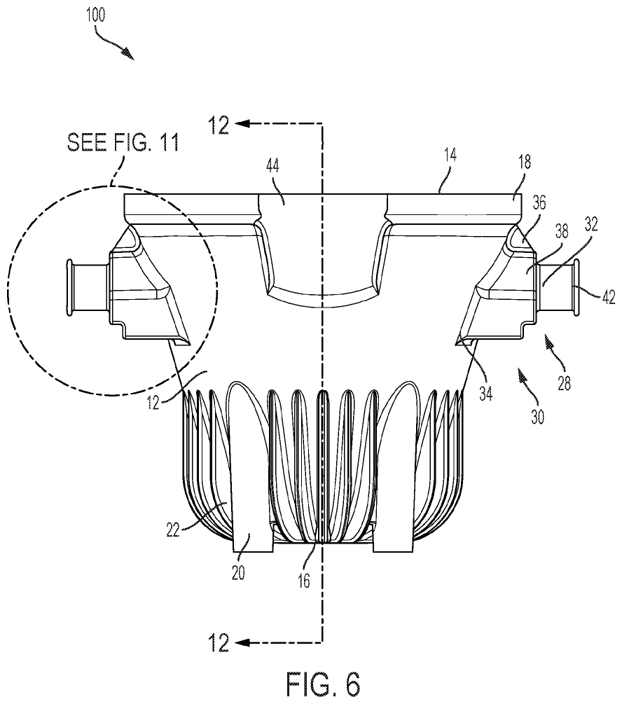

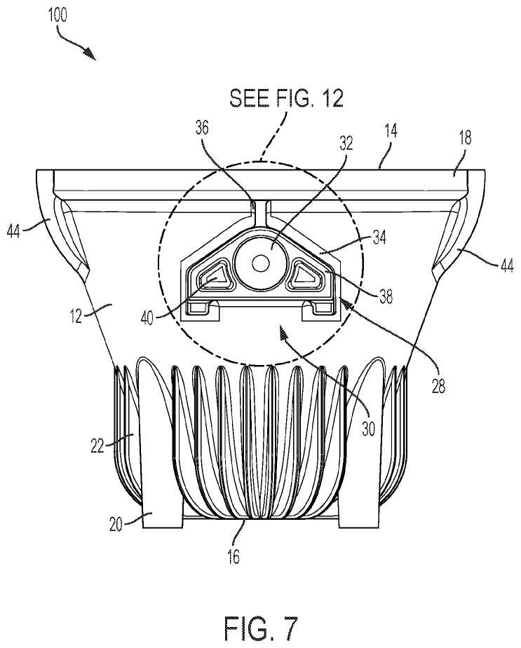

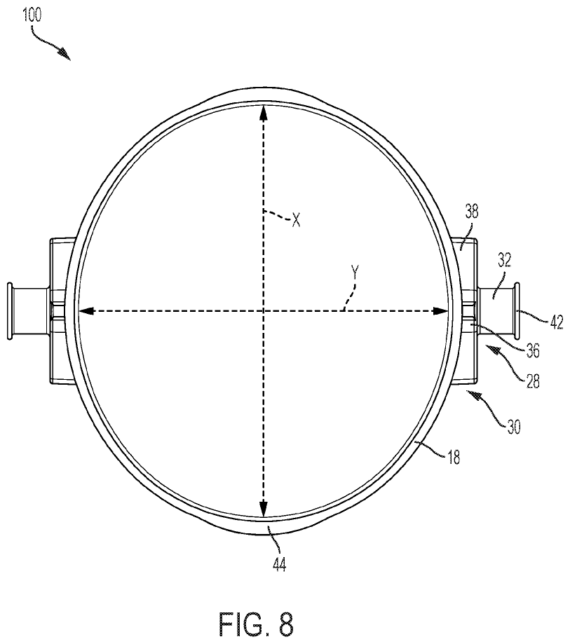

A reinforcement ring 18 is provided at the open top end 14 of the cooling vessel 10, 100. The reinforcement ring 18 has a thickness that is greater than the thickness (tₒ) of the sidewall 12 at the open top end 14 creating a flange extending laterally outward from the sidewall 12. The reinforcement ring 18 may have a stepped outer profile as shown in FIGS. 6 and 7.

Legs 20 may be provided at the closed bottom end 16 of the cooling vessel 10, 100. The legs 20 may extend upwardly along the sidewall 12 and/or downwardly beyond the closed bottom end 16 of the cooling vessel 10, 100. Any number of legs 20 may be provided in order to stably support the cooling vessel 10, 100. In the embodiments, shown in FIGS. 1 and 5, four legs 20 are provided.

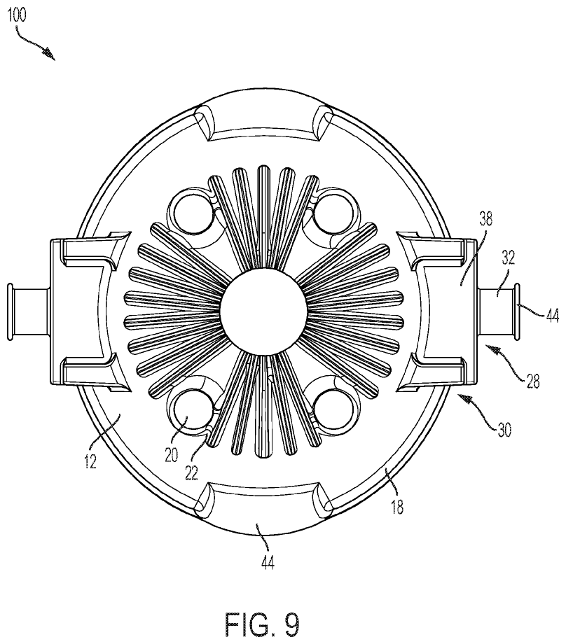

As shown in FIGS. 5-7, 9, 10, and 13, cooling fins 22 may extend laterally outward from the exterior surface of the sidewall 12 of the cooling vessel 10, 100. The cooling fins 22 may extend upward from the closed bottom end 16 along a portion of the exterior surface of the sidewall 12 that is at least 0.1 and up to 0.6 the length of the sidewall 12 as measured from the open top end 14 to the closed bottom end 16, for example, 0.1-0.6 the length of the sidewall 12, 0.2-0.5 the length of the sidewall 12 or 0.3-0.4 length of the sidewall 12. The cooling fins 22 may have a thickness of at least 40 mm and up to 80 mm, for example, 40-80 mm or 50-70 mm. The outer perimeter of each cooling fin 22 may have a vertical upper portion 24 and a curved g 26. The curved lower portion 26 may have a radius of at least 10 mm and up to 40 mm, for example, 10-40 mm, 15-35 mm, or 20-30 mm. Any number of cooling fins 22 may be provided. The cooling fins 22 are uniformly spaced around the circumference of the cooling vessel 10, 100 in order to provide uniform cooling. In the embodiment shown in FIGS. 5-7, 9, 10, and 13, thirty-six cooling fins 22 are provided.

Two trunnions 28 for lifting the cooling vessel 10, 100 are provided on opposite sides of the cooling vessel 10, 100 along the minor axis Y. Each trunnion 28 comprises a reinforcing assembly 30 and a trunnion ring 32. The reinforcing assembly 30 comprises a reinforcement plate 34, at least one gusset 36, and a reinforcing structure 38 having at least one flute 40. The reinforcement plate 34 extends laterally outward from the sidewall 12 of the cooling vessel 10, 100 and is used to attach the reinforcing structure 38 to the cooling vessel 10, 100. The reinforcing structure 38 extends laterally outward from the reinforcement plate 34 and surrounds the base portion of the trunnion ring 32 to provide additional structural support to the trunnion ring 32 and to distribute the stress placed on the trunnion ring 32 when the cooling vessel 10, 100 is lifted. The reinforcing structure 38 includes a least one flute 40 or opening extending through the reinforcing structure 38 in order to protect the reinforcing structure 38 from vertical deformation and to stiffen the trunnion 28. The at least one gusset 36 extends from an upper portion of the reinforcing structure 38 to the reinforcement ring 18 of the cooling vessel 10, 100, thereby transferring vertical stress from the trunnion 28 to the reinforcement ring 18. The trunnion ring 32 extends laterally outward beyond the reinforcing assembly 30 and has a flange 42 on its outmost end.

The cooling vessel 10, 100 may also include at least one impact pad 44 to distribute stress when the cooling vessel 10, 100 is impacted against a surface, such as the ground, in order to dislodge solidified material. The cooling vessel 10, 100 may have two impact pads 44. The impact pads 44 are located at the open top end 14 of the cooling vessel 10, 100 and extend laterally outward from the reinforcement ring 18 and the sidewall 12 of the cooling vessel 10, 100. The impact pads 44 may be provided on opposite sides of the cooling vessel 10, 100 along the major axis X. The impact pads 44 may extend along a portion of the exterior surface of the sidewall 12 that is at least 0.1 and up to 0.4 the length of the sidewall 12 as measured from the open top end 14 to the closed bottom end 16, for example, 0.1-0.4 the length of the sidewall 12 or 0.2-0.4 length of the sidewall 12.

The cooling vessel may be made from fully-killed, vacuum degassed, cast steel that is processed to have a fine grain size to improve toughness and elongation. The steel may have a tensile strength of less than 450 MPa, a yield strength of greater than 240 MPa, and elongation of greater than 30%. The steel may comprise 3.8 wt. % carbon and 2.4 wt. % silicon. The microstructure of the steel may contain at least 80% ferrite, be free of large carbides, and have only nodular graphite. The steel of the cooling vessel may be annealed by austenitizing above the Aᵣ₃ temperature followed by controlled cooling to 600-630° C., isothermal holding at this temperature, and further controlled cooling to 300° C. The cooling vessel may then be descaled and the interior surface may be machined as necessary to remove discontinuities that may cause the contents of the cooling vessel to stick.

The cooling vessel is used for the recovery of metal from waste products produced during the smelting or melting of non-ferrous or ferrous metals. Molten waste product, for example, converter slag from a copper smelting operation, is placed in the cooling vessel. The waste product may be at a temperature of from 1100-1650° C., for example, 1200° C. The cooling vessel is then subjected to a combination of ambient and accelerated cooling using water and/or air. During the cooling and crystallization of the waste product, material containing high levels of metal and having higher specific gravity settles to the bottom of the cooling vessel while waste material comprising lighter compounds containing little or no metal separate to the top of the cooling vessel. When the metal-containing material has solidified and the waste material has solidified sufficiently to form a shell that is thick enough to allow removal of the solidified mass from the cooling vessel, the cooling vessel is tipped and, if necessary, impacted on the ground to remove the solidified mass. The solidified mass comprises a button of metal-containing material with a thick layer of waste material on its upper surface.

The inventive cooling vessel has several features described above that allow the metal recovery process to be completed in 80% less time than prior art processes. First, gravitation of the metal-containing material to the bottom of the cooling vessel is enhanced by the angle of the inclination of the sidewall, the oval cross-section of the vessel, and the thickness of the sidewall of the cooling vessel. In addition, the angle of the inclination of the sidewall helps to reduce stresses which can result in deformation and reduce the life of the cooling vessel. Second, the thicker sidewall at the closed bottom end of the cooling vessel and the cooling fins assist in cooling the metal-containing material more quickly. Third, overall geometry of the cooling vessel allows for easy removal of the solidified mass from the cooling vessel. Fourth, the cooling vessel geometry combined with the ambient and accelerated cooling, allows the metal-containing material to solidify before a solid crust develops on the top surface of the waste product forming an insulating cover that increases the required cooling time. As a result of the decreased cooling time, the same volume of waste product can be treated with 70-75% less cooling vessels, for example, a production facility using prior art cooling vessels that required 54 cooling vessels will require only 14 of the inventive cooling vessels. In addition, the produced concentrate may be directly returned to the smelting or melting process without any further refining processes that may be required when using the prior art cooling vessels and processes.

It is to be understood that the invention may assume various alternative variations and step sequences, except where expressly specified to the contrary. It is also to be understood that the specific devices and processes illustrated in the attached drawings, and described in the specification, are simply exemplary embodiments or aspects of the invention. Although the invention has been described in detail for the purpose of illustration based on what is currently considered to be the most practical and preferred embodiments or aspects, it is to be understood that such detail is solely for that purpose and that the invention is not limited to the disclosed embodiments or aspects, but, on the contrary, is intended to cover modifications and equivalent arrangements that are within the spirit and scope thereof. For example, it is to be understood that the present invention contemplates that, to the extent possible, one or more features of any embodiment or aspect can be combined with one or more features of any other embodiment or aspect.

1. A cooling vessel for metal recovery from waste products comprising:
a first open end;
a second closed end; and
a sidewall extending between the first open end and the second closed end,
the vessel having a longitudinal central axis extending from the first open end to the second closed end,
wherein, in a plane including the longitudinal central axis and extending in a direction from the first open end to the second closed end, opposing interior surfaces of the vessel are at an angle of 30°-50° to one another, and
wherein a thickness of the sidewall at the first open end is greater than a thickness of the sidewall adjacent the second closed end.

2. The cooling vessel of claim 1, wherein opposing interior surfaces of the vessel are at an angle of 35°-45° to one another.

3. The cooling vessel of claim 1, wherein a ratio of the thickness of the sidewall adjacent the second closed end to the thickness of the sidewall at the first open end is 1.1-2.0.

4. The cooling vessel of claim 1, wherein a ratio of the thickness of the sidewall adjacent the second closed end to a thickness of the sidewall at the first open end is 1.2-1.7.

5. The cooling vessel of claim 1, wherein, for a cross-section of the vessel taken perpendicular to the longitudinal central axis, an inner surface of the vessel has a first major axis that is perpendicular to a second minor axis and a diameter of the inner surface of the vessel along the first major axis is greater than a diameter of the vessel along the second minor axis.

6. The cooling vessel of claim 5, wherein a ratio of the diameter of the inner surface of the vessel along the first major axis to the diameter of the inner surface of the vessel along the second minor axis is 1.05-1.50.

7. The cooling vessel of claim 5, wherein a ratio of the diameter of the inner surface of the vessel along the first major axis to the diameter of the inner surface of the vessel along the second minor axis is 1.1-1.4.

8. The cooling vessel of claim 5, wherein the cross-section of the inner surface of the vessel is oval.

9. The cooling vessel of claim 1, wherein an interior surface of the second closed end is rounded.

10. The cooling vessel of claim 1, wherein the second closed end has a thickness that is equal to or greater than a thickness of the sidewall adjacent the second closed end.

11. The cooling vessel of claim 10, wherein a ratio of the thickness of the sidewall adjacent the second closed end to the thickness of the second closed end is 0.8-1.0.

12. The cooling vessel of claim 1, further comprising a reinforcement ring provided at the first open end, the reinforcement ring having a thickness that is greater than a thickness of the sidewall at the first open end and creating a flange extending laterally outward from the sidewall.

13. The cooling vessel of claim 1, further comprising a plurality of cooling fins extending laterally outward from an exterior surface of the sidewall and upward along the exterior surface of the sidewall from the second closed end.

14. The cooling vessel of claim 13, wherein the plurality of cooling fins extend 0.1-0.6 of a length of the sidewall as measured from the first open end to the second closed end.
